(19) United States
(12) Patent Application Publication
(10) Pub. No.: US 2006/0146824 A1
(43) Pub. Date: Jul. 6, 2006

(54) Mobile station and content playback method thereof

(75) Inventor: Katsuya Miyata, Yokohama (JP)

Correspondence Address: COHEN, PONTANI, LIEBERMAN & PAVANE, Suite 1210, 551 Fifth Avenue, New York, NY, 10176, US

(73) Assignee: Casio Hitachi Mobile Communications Co., Tokyo (JP)

(21) Appl. No.: 11/274,827

(22) Filed: Nov. 14, 2005

(30) Foreign Application Priority Data
Nov. 15, 2004 (JP) 2004-330295

(51) Int. Cl. H04L 12/56

(52) U.S. Cl. 370/390

(57) ABSTRACT

When a voice incoming call occurs during multicast content playback, a control section interrupts multicast content playback after storing the multicast service execution status at that time point in a storage section. After a voice call is completed, the control section confirms whether or not the multicast content for which playback has been interrupted can be distributed at that location and, when distribution is possible, confirm whether or not the multicast content has been actually distributed. Then, if in distribution, the control section resumes multicast content playback.

### CROSS-REFERENCE TO RELATED APPLICATION

This application is based upon and claims the benefit of priority from the prior Japanese Patent Application No. 2004-330295, filed Nov. 15, 2004, the entire contents of which is incorporated herein by reference.

### BACKGROUND OF THE INVENTION

1. Field of the Invention

The present invention relates to a mobile station that utilizes a multicast service and associated content playback method.

2. Description of the Related Art

In recent years, a service which distributes content containing images, audio, etc. in a broadcast environment to multiple users via a cable broadband line such as ADSL, FTTH (Fiber To The Home) is spreading. Such multicast service utilizes an IP multicast technique known as IGMP (Internet Group Management Protocol). On the other hand, anticipation for multicast service provision by wireless is increasing with the proliferation of cellular phones and sophisticated features. A concrete method for providing multicast service using a cellular phone has been proposed (for example, as disclosed in Japanese Laid-Open (Kokai) Patent Application No. 2001-308856 titled “METHOD AND SYSTEM FOR PROVIDING MULTI-CAST SERVICE, INFORMATION DISTRIBUTING DEVICE AND RADIO TERMINAL”).

In this multicast service, each base station distributes multicast content by way of a multicast service Forward Traffic Channel. Furthermore, the base stations also transmit information (hereinafter, denoted as “multicast service parameters”) pertaining to the distributable multicast content ID which indicates the multicast content currently being distributed, mapping information for the multicast content and physical channel, and various information required by the transfer terminals (mobile stations) such as channel configuration (frequency, data rate, etc.) of the physical channel for using the multicast service.

The transfer terminals do not need to execute line establishment processing such as a general voice call or a data call. All of the transfer terminals using multicast service receive multicast content by monitoring the same multicast channel.

Moreover, the base stations can discontinue distribution of multicast content not being received by whichever transfer terminals in order to control waste of channel resources. There are two methods used to accomplish this task. In one of these methods, a distribution continuation acknowledge request is periodically transmitted to the transfer terminals from a base station. The transfer terminals which receive a distribution continuation acknowledge request respond by transmitting a distribution continuation acknowledge response. The response message includes information which indicates the multicast content currently being received. Otherwise, whenever a positive distribution continuation acknowledge response is not obtained, a base station presumes that a transfer terminal to receive the multicast content is not present and distribution is discontinued. Concerning distribution of discontinued multicast content, distribution resumes when a distribution restart request is submitted.

In the second method, when a transfer terminal commences reception of multicast content, a reception start notification is transmitted which includes information indicating the multicast content. Conversely, when a transfer terminal terminates reception, a reception end notification is transmitted which includes information indicating the multicast content. Accordingly, a base station can determine the number of transfer terminals receiving multicast content and which transfer terminals are receiving the multicast content. A base station will resume distribution when a reception restart notification is received during distribution suspension, as well as distribution will be discontinued when a reception end notification of a terminating transfer terminal is received during distribution.

Apart from that, a case where a voice incoming call can be received during use of a multicast service has been considered. In a situation where a data call and a voice call can be carried out using the same line, a method of switching the line for use as a voice call at the time of a voice incoming call and switching the line for use as a data call after ending a voice call to resume a data call has been proposed (for example, as disclosed in Japanese Laid-Open (Kokai) Patent Application No. H10-200649 (1998) titled “SPEECH AND DATA COMMUNICATION AUTOMATIC CHANGEOVER DEVICE”).

Incidentally, with regard to operation of a transfer terminal when there is a voice incoming call during use of a multicast service, two methods have been considered for performing a voice call while continuing reception of multicast content and for performing a voice call while suspending reception of multicast content. In the case of the latter method, when a voice call is completed and if the same multicast content being received before the call is distributed, it is preferable to automatically resume reception of that multicast content.

Although the purpose of the conventional prior art disclosed in the above-mentioned JP H10-200649 (1998) has the same effect, when a voice call is completed, the line is always switched to a data call. Even if in the case where a data call does not need to be resumed, the transfer terminal will be in a line establishment state. In other words, especially in the case of wireless communication, this constitutes a waste of channel resources and becomes a significant problem. Consequently, it is preferable to resume a data call only when required corresponding to the circumstances after the end of a voice call.

### SUMMARY OF THE INVENTION

The object of the present invention is to provide a mobile station and associated content playback method which achieves efficient application of channel resources and enhances user-friendliness.

In order to achieve the above-mentioned object, a mobile station according to the present invention which receives and performs playback of multicast content transmitted from a base station, comprising a playback means for performing playback of multicast content transmitted from a base station; an interruption detection means for detecting an interruption request pertaining to playback of multicast content by the playback means; a storage means for storing multicast service execution status information at the same time point when a playback interruption instruction pertaining to multicast content has been detected by the interruption detection means; an interruption means for interrupting playback of multicast content by the playback means; an information acquisition means for acquiring multicast service information pertaining to multicast service currently available which is included in a message transmitted from a base station; a resumption suitability determination means for determining multicast service resumption suitability based on multicast service information acquired by the information acquisition means and multicast service execution status information stored in the storage means after a multicast content playback interruption by the interruption means; and a multicast service resumption means for resuming playback of multicast content by the playback means when judged that multicast service resumption is possible by the resumption suitability determination means.

In order to achieve the above-mentioned object, a content replay method according to the present invention receives and performs playback of multicast content transmitted from a base station, comprising the steps of storing multicast service execution status information at the same time point when a communication start request transpires while performing playback of multicast content transmitted from the base station; interrupting playback of the multicast content; acquiring multicast service information pertaining to multicast service currently available which is included in a message transmitted from a base station; determining multicast service resumption suitability based on multicast service information and the multicast service execution status information acquired after completing the communication; and resuming the multicast content playback when judged that multicast service resumption is possible.

According to the present invention, when a playback interruption instruction is detected by the interruption detection means during playback of multicast content by the playback means, the multicast service execution status information at that same time point is stored in the storage means and playback of multicast content is interrupted by the interruption means. Multicast service information is acquired pertaining to multicast service currently available which is included in a message transmitted from a base station by the information acquisition means. The multicast service resumption suitability is judged by the multicast service resumption determination means based on multicast service information and multicast service execution status information after a playback interruption of the multicast content. When judged that resumption is possible, playback of the multicast content is resumed by the multicast service resumption means. Accordingly, efficient application of channel resources can be achieved and the advantage that user-friendliness can be enhanced is acquired.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing the configuration of a mobile station according to the preferred embodiment of the present invention;

FIG. 2 is a flow chart for explaining a multicast service interruption process related to the preferred embodiment;

FIG. 3 is a flow chart for explaining another example of a multicast service interruption process related to the preferred embodiment;

FIG. 4 is a flow chart for explaining a multicast service resumption suitability determination processing related to the preferred embodiment; and

FIG. 5 is a flow chart for explaining a multicast service resumption process.

### DETAILED DESCRIPTION OF THE PREFERRED EMBODIMENTS

Hereinafter, the preferred embodiments of the present invention will be explained with reference to the drawings.

A. Configuration of the Preferred Embodiments

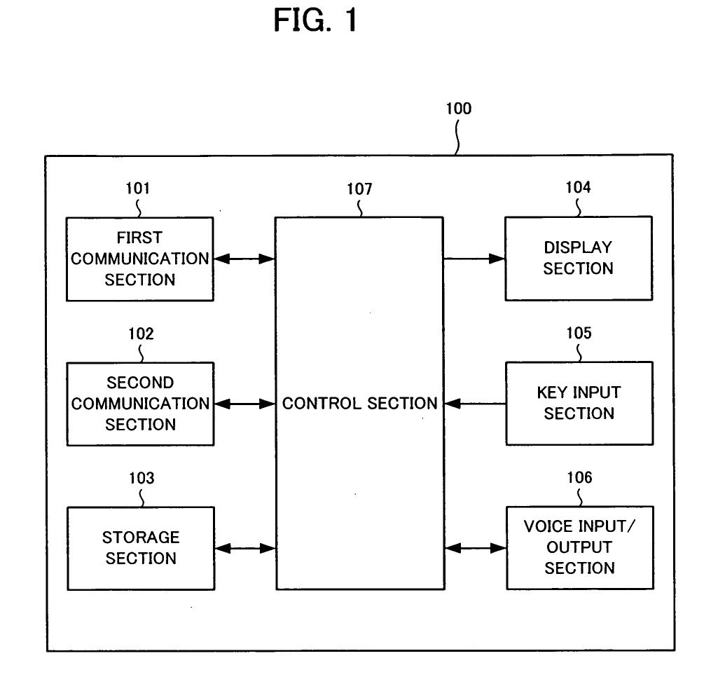

FIG. 1 is a block diagram showing the configuration of a mobile station 100 according to the preferred embodiment of the present invention. A mobile station 100 comprises a first communication section 101, a second communication section 102, a storage section 103, a display section 104, a key input section 105, a voice input-output section 106 and a control section 107. The first communication section 101 connects with a wireless and/or cable communication line to execute a voice call, such as a telephone call etc. and a data call, such as E-mail, web (Internet), etc. The first communication section 101 comprises a modulation means and a demodulation means for performing modulation and demodulation of transmitted and received data, respectively.

Next, the second communication section 102 receives multicast content via a wireless link, as well as performs transmission and reception of the control messages for multicast service use. Also, the second communication section 102 comprises a modulation means and a demodulation means for performing modulation and demodulation of transmitted and received data, respectively. Specifically, the multicast service parameters which a base station transmits are received and the information required for using the multicast service is acquired. Also, in accordance with the channel configuration for the stated multicast channel with the multicast service parameters, monitoring of that channel is performed and multicast content is received. Furthermore, the control information, such as a distribution start request, a distribution suspension notification, etc. of multicast content is transmitted to a base station.

The storage section 103 is for storage of programs, audio, images, E-mail, web, other user data, etc. and can be comprised of memory built into the mobile station, any external memory, such as a removable memory card, etc.

The display section 104 is a display screen, such as a liquid crystal display, etc. which displays images of received multicast content, E-mail, web, a basic operation screen, etc. Also, the display section 104 may be comprised of a plurality of display screens, for example a main screen and a sub-screen. The key input section 105 accepts input from a user corresponding to a ten-key pad, function keys, a touch panel, audio input, etc. The voice input-output section 106 is comprised with a voice input section, such as a microphone, etc., which converts inputted voice into a signal and an voice output section, such as a speaker, etc., which outputs voice.

The control section 107 performs control of the entire mobile station 100, namely, the first communication section 101, the second communication section 102, the storage section 103, the display section 104, the key input section 105, the voice input-output section 106, etc. For example, when a user performs a voice call manipulation via the key input section 105, the control section 107 controls the first communication section 101 based on a communication line establishment processing program for voice calls stored in the storage section 103 and establishes a communication line. When a communication line has been established that outcome will be displayed in the display section 104. The voice signal inputted from the voice input-output section 106 is transmitted to a call partner via the first communication section 101. On the other hand, control is perform for outputting the voice data received via the first communication section 101 as a voice signal from the voice input-output section 106.

Additionally, as a separate example, when multicast content is received via the second communication section 102, the control section 107 performs playback of the multicast content based on a multicast content playback program contained in the storage section 103 and the images are displayed in the display section 104, as well as performs control of voice outputted from the voice input-output section 106.

Furthermore, the present invention is not restricted to the configuration explained here. For example, instead the first communication section 101 and the second communication section 102 being separate modules, both can be configured as a combined module. Accordingly, a miniaturized apparatus can be achieved.

B. Operation of the Preferred Embodiments

B-1. Interruption Processing of Multicast Service

### EXAMPLE 1

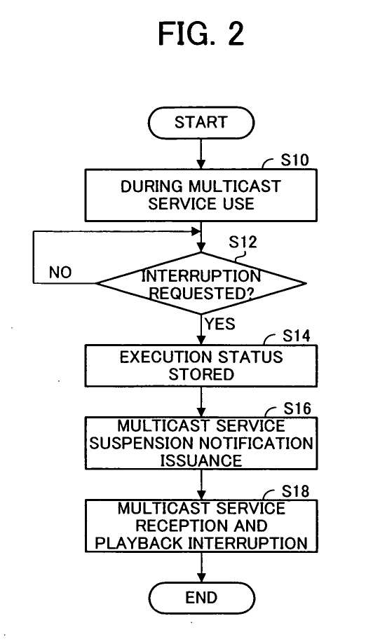

Next, FIG. 2 is a flow chart for explaining operation when interrupting multicast service in the mobile station 100 according to the preferred embodiment.

Hereinafter, operation will be explained for each step. First, the mobile station 100 is presumed to be during multicast service use (Step S10). During this period, the control section 107 judges whether or not a multicast service interruption request has been issued (Step S12). While this is not particularly limited to an instance when a multicast service interruption request has been issued, for example, an occasion when there is a voice incoming call, a case where a user performs interruption processing intentionally when the housing of a foldable type mobile station is closed, etc. can be judged.

On occasions when detected that a multicast service interruption request has been issued, the control section 107 switches to multicast service interruption processing. First, the control section 107 stores the multicast service execution status at that time point in the storage section 103 (Step S14). The multicast service execution status information includes, for example, the content ID which identifies the received multicast content, the channel configuration for the multicast channel, etc.

Next, the control section 107 transmits a multicast service suspension notification to a base station for the multicast content received until just before via the second communication section 102 (Step S16). Multicast content reception and playback processing are suspended (Step S18).

In addition, as a different process from the processing mentioned above, an example in which the execution sequence of Step S14, Step S16 and Step S18 are replaced can also be considered. Also, an example which skips Step S16 can also be considered.

B-2. Interruption Processing of Multicast Service

### EXAMPLE 2

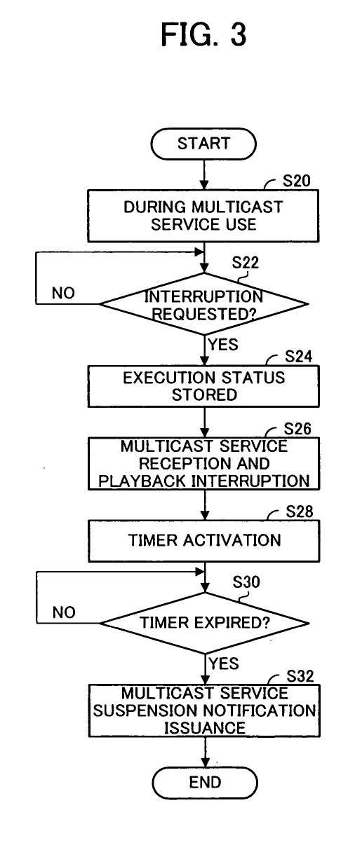

Next, FIG. 3 is a flow chart for explaining another operation example when interrupting multicast service in the mobile station 100 according to the preferred embodiment. In FIG. 3, the processing Steps S20-S24 are the same as the Steps S10-S14 in FIG. 2. First, the mobile station 100 is presumed to be during multicast service use (Step S20). During this period, the control section 107 judges whether or not a multicast service interruption request has been issued (Step S22). On occasions when detected that a multicast service interruption request has been issued, the control section 107 stores the multicast service execution status at that time point in the storage section 103 (Step S24).

Subsequently, multicast content reception and playback suspension processing are performed (Step S26). This processing is the same processing as Step S18 of FIG. 2. Then, the control section 107 activates a timer (Step S28). The timer value may be a fixed value determined in advance, may be a variable value corresponding to the category of interrupted multicast content or may be a variable value corresponding to an interruption reason (for example, user manipulated, a specific application has been started, etc.). In any of these cases, the control section 107 checks whether or not the timer has expired (Step S30). When expired, the multicast service suspension notification transmission processing of Step S32 will be performed. This processing is the same process as Step S16 of FIG. 2.

Although not shown, in advance of the timer expiring, a multicast service resumption request is issued, etc. and the interruption sequence being suspended can also be considered. Besides, in a case of activating separate processing (a voice call, application, etc.) after interrupting multicast service based on this interruption sequence, the above-mentioned start process may be commenced after executing Step S32 or the above-mentioned start process may be commenced after Step 28 without waiting for execution of Step S32.

In this manner, after performing multicast content reception and playback suspension processing in Step S26, a fixed time difference will be set until executing a multicast service suspension notification transmission process in Step S32. Since the multicast service suspension notification is not transmitted to the base station in cases where a multicast service resumption request is issued before the timer expires, a restart procedure can be performed in a shorter time.

B-3. Resumption Suitability Determination Processing of Multicast Service

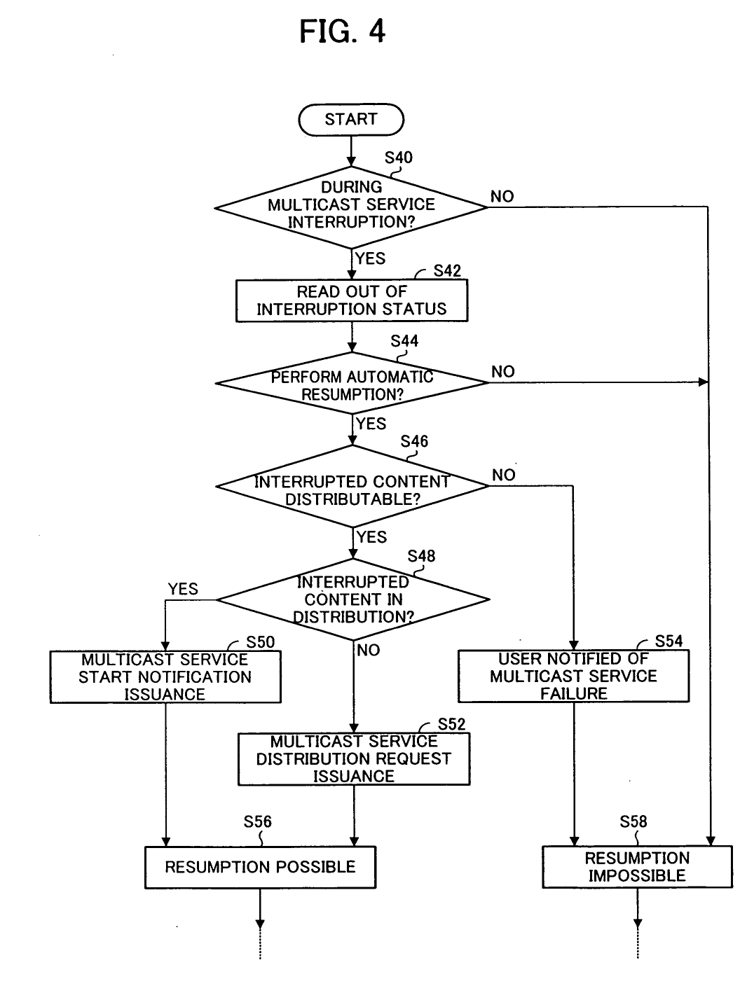

Next, FIG. 4 is a flow chart for explaining operation when determining multicast service resumption suitability in the mobile station 100 according to the preferred embodiment. Hereinafter, operation will be explained for each step.

First, the control section 107 judges whether or not the mobile station is in the midst of a multicast service interruption (Step S40). This can be learned by whether or not there is a multicast service interruption record in the storage section 103. When not during an interruption, the control section 107 judges resumption is impossible and processing is finished (Step S58). On the other hand, when in the midst of an interruption, the control section 107 will read out the multicast service interruption status information from the storage section 103 (Step S42). This corresponds to the multicast service execution status information stored in the storage section 103 in the multicast service interruption processing.

Next, the control section 107 judges whether or not automatic resumption of multicast service is to be performed (Step S44). Specifically, for example, when a user selects “automatic resumption ON” or “automatic resumption OFF” via the key input section 105 in advance, automatic resumption information is stored in the storage section 103. There is the method of judging whether or not automatic resumption is to be performed with reference to this automatic resumption setup information. Besides, not only by a simple automatic resumption ON/OFF setup, the control section 107 may judge whether or not automatic resumption is to be performed in a combination, for example, a type of multicast content for which reception has been interrupted, an interruption reason, current time, present location, etc. Then, when judged automatic resumption is not to be performed, the control section 107 judges resumption is impossible and processing is finished (Step S58). On the other hand, when judged automatic resumption is to be performed, the control section 107 confirms whether or not the multicast content which had the reception interrupted can be distributed at that location (Step S46). During mobile station interrupted reception, the locations which do and do not provide the multicast service are provided. This is because a mobile station may travel to a location which is not distributing the multicast content which had reception interrupted. As a verification method, since a multicast content ID list is included in the multicast service parameters which a base station transmits, it is only necessary to compare this with the multicast content ID included in the multicast service interruption status information read out at Step S42.

Moreover, when multicast service parameters cannot be received from a base station in a fixed period, the control section 107 judges distribution as not being available. Otherwise, in the case of being outside the range or a mobile station that can communicate by a plurality of communication methods, when waiting for only a communication method, it is understood that the multicast service is not provided in advance. Also, in case where undeliverable, the user is notified that resuming reception of the multicast content is impossible for reception which has been interrupted and displayed in the display section 104. (Step S54). The control section 107 judges resumption is impossible and processing is finished (Step S58).

On the other hand, when distribution is possible, the control section 107 will confirm whether or not that multicast content is actually being distributed (Step S48). Since the information included in the multicast service parameters which a base station transmits and indicates whether or not distributable multicast content is currently being distributed, this can be used as a verification method.

When the multicast content is in distribution, the control section 107 will transmit a multicast service start notification which resumes reception to a base station via the second communication section 102 (Step S50). The control section 107 will judge resumption is possible and will finish processing (Step S56). On the other hand, when in a state where distribution is suspended, the control section 107 will transmit a multicast service distribution request for the desired multicast content to resume reception to a base station via the second communication section 102 (Step S52). The control section 107 will judge resumption is possible and will finish processing (Step S56).

Furthermore, in the above-mentioned operation, an example which omits Step S50 is also considered.

B-4. Restart Procedure

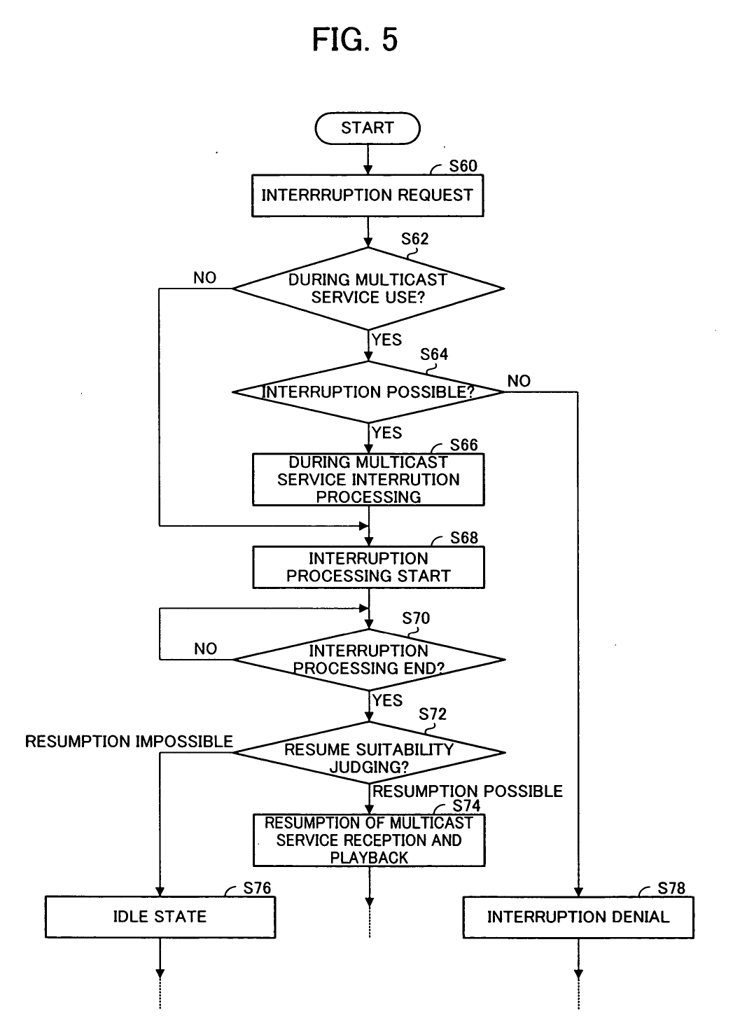

Next, FIG. 5 is a flow chart for explaining the sequence of operation after interrupting multicast service until resumption in the mobile station 100 according to the preferred embodiment. Hereinafter, operation will be explained for each step.

First, the control section 107 detects an interruption request (Step S60). Here, interruption requests are, for example, a voice incoming call from a base station, a voice communication request to start a voice transmission operation from a user, a data communication request to start data incoming or a data transmission operation other than multicast service. Otherwise, corresponding to this are various application start requests contained in the storage section 103, various device start requests, etc. The control section 107 which detects an interruption request will judge whether or not during multicast service use (Step S62). Specifically, the control section 107 judges whether or not the second communication section 102 is activated and confirming whether or not the multicast content playback program contained in the storage section 103 is activated. When not during multicast service use, the control section 107 commences processing corresponding to the content of the interruption request (Step S68).

On the other hand, in cases where during multicast service use, the control section 107 judges whether nor not interruption is possible (Step S64). Specifically, for example, when a user selects “interruption is possible” or “interruption is impossible” via the key input section 105 in advance, interruption suitability setup information is stored in the storage section 103 and this process judges whether or not to interrupt with reference to this interruption suitability setup information. Besides, not only by a simple interruption possible/impossible setup, the control section 107 may judge whether or not an interruption is to be performed in a combination, for example, a type of multicast content during reception, a type of interruption request, current time, present location, etc. Then, when judged interruption is impossible, the control section 107 switches to an interruption request operation (Step S78).

On the other hand, when judged interruption is possible, the control section 107 switches to multicast service interruption processing (Step S66). In this multicast service interruption process, the flow chart shown in FIG. 2 or FIG. 3 mentioned above is executed. When multicast service interruption processing is completed, the control section 107 will commence processing corresponding to the content of the interruption request (Step S70). Subsequently, the control section 107 waits for this interruption processing to conclude (Step S70).

Then, upon detection of interruption processing being completed, the control section 107 will perform multicast service resumption suitability determination processing (Step S72). In this multicast service resumption suitability determination processing, the flow chart shown in FIG. 4 mentioned above is executed. Here, when judged resumption is possible, the control section 107 resumes reception and playback of multicast content (Step S74).

On the other hand, when judged resumption is impossible, it will run normally without performing a particular operation and switches to an idle state (Step S76). Accordingly, the present invention makes it possible to resume multicast service use automatically after the end of interruption processing based on a favorite setup of the user and without a user manipulating resumption of a multicast service. Besides, when becoming impossible to use a multicast service, it is not necessary to perform unnecessary distribution request transmissions and reception processing and a user can be notified when becoming impossible to use a multicast service.

While the present invention has been described with reference to the preferred embodiments, it is intended that the invention be not limited by any of the details of the description therein but includes all the embodiments which fall within the scope of the appended claims.

What is claimed is:

1. A mobile station which receives and performs playback of multicast content transmitted from a base station, comprising:
a playback means for performing playback of multicast content transmitted from a base station;
an interruption detection means for detecting an interruption request pertaining to playback of multicast content by said playback means;
a storage means for storing multicast service execution status information at the same time point when a playback interruption instruction pertaining to multicast content has been detected by said interruption detection means;
an interruption means for interrupting playback of multicast content by said playback means;
an information acquisition means for acquiring multicast service information pertaining to multicast service currently available which is included in a message transmitted from a base station;
a resumption suitability determination means for determining multicast service resumption suitability based on multicast service information acquired by said information acquisition means and multicast service execution status information stored in said storage means after a multicast content playback interruption by said interruption means; and
a multicast service resumption means for resuming playback of multicast content by said playback means when judged that multicast service resumption is possible by said resumption suitability determination means.

2. The mobile station according to claim 1, wherein said execution status information includes content identification information for identifying said multicast content during reception and playback.

3. The mobile station according to claim 1, wherein said execution status information includes channel information for indicating channel on which said multicast content is being transmitted.

4. The mobile station according to claim 1, wherein said multicast service information includes content identification information for identifying said multicast content which said base station can distribute and distribution status information for indicating whether or not said multicast content is currently being distributed.

5. A content replay method which receives and performs playback of multicast content transmitted from a base station, comprising the steps of:
storing multicast service execution status information at the same time point when a communication start request transpires while performing playback of multicast content transmitted from said base station;
interrupting playback of said multicast content;
acquiring multicast service information pertaining to multicast service currently available which is included in a message transmitted from a base station;
determining multicast service resumption suitability based on multicast service information and said multicast service execution status information acquired after completing said communication; and
resuming said multicast content playback when judged that multicast service resumption is possible.

6. The content replay method according to claim 5, further comprising the steps of:
discriminating whether or not said base station can possibly distribute said multicast content for which playback has been interrupted to provide a discrimination result after completing said communication; and
judging said multicast service resumption based on said discrimination result.

7. The content replay method according to claim 6, further comprising the steps of:
transmitting said multicast content distribution request to said base station when said base station discriminates that distribution is possible of said multicast content for which playback has been interrupted and not yet distributed; and
resuming playback of multicast content after completing said communication.
